(19) United States
(12) Patent Application Publication
(10) Pub. No.: US 2004/0226910 A1
(43) Pub. Date: Nov. 18, 2004

(54) Bulk optical elements incorporating gratings for optical communications and methods for producing

(76) Inventors: Dilip K. Chatterjee, Rochester, NY (US); John F. Filhaber, East Haddam, CT (US); John R. Marciante, Webster, NY (US); Jeff Hirsh, Bradford, VT (US); Larry Mann, Painted Post, NY (US); Daniel H. Raguln, Acton, MA (US); Robert Sabia, Corning, NY (US); Dennis W. Smith, Corning, NY (US); Tony L. Whitman, Webster, NY (US)

Correspondence Address: CORNING INCORPORATED, SP-TI-3-1, CORNING, NY, 14831

(21) Appl. No.: 10/747,587

(22) Filed: Dec. 29, 2003

Related U.S. Application Data
(60) Provisional application No. 60/437,250, filed on Dec. 30, 2002.

(51) Int. Cl. B29D 11/00

(52) U.S. Cl. 216/24

(57) ABSTRACT

Methods of forming bulk optical elements, such as prisms, incorporating gratings are disclosed. Grating structures are formed by etching a uniform-thickness or generally planar substrate. Direct bonding, particularly chemical bonding, is then employed to bond the etched planar substrate to a bulk optical material without the use of adhesives or high temperature fusion.

This application claims the benefit of priority under 35 U.S.C. § 119(e) of U.S. Provisional Application Ser. No. 60/437,250 filed on Dec. 30, 2002.

### FIELD OF THE INVENTION

This invention relates to bulk optical elements incorporating gratings and to methods and processes for producing such elements. More particularly, the invention relates bulk optical elements, such as prism elements, incorporating gratings, and to methods and processes for producing bulk optical elements incorporating gratings, desirably by a combination of both an etching process and a direct bonding process.

### BACKGROUND OF THE INVENTION

In wavelength-multiplexed optical communications systems such as fiber-based DWDM, different wavelengths or wavelength channels carry different data. Yet many such wavelengths may be present in a single optical path simultaneously. These systems thus require tools to separate and combine various wavelengths. Today the tools of choice for such wavelength separation and wavelength combination are fabry-perot-like thin film filters, phased arrays, and diffraction gratings.

Thin-film filters are useful to separate out an individual wavelength or a group of wavelengths from a wavelength-multiplexed optical signal. But multiplexing or de-multiplexing many wavelengths simultaneously generally requires cascading many thin film filters. Phased arrays are also difficult to apply where many wavelengths are to be multiplexed or de-multiplexed simultaneously. For such applications, diffraction gratings are generally preferred.

Most diffraction gratings on the market are replicated. A grating master is created by holographic exposure onto photoresist or by diamond tool machining. Then metal is deposited onto the master and lifted off with a polymer on glass. The metal/polymer/glass sandwich is then employed as a replicated grating.

Other gratings are etched into flat glass substrates using photoresist as a mask. Gratings of this type are used for UV laser exposure to generate an interference pattern into glass fiber to create fiber gratings.

Still other gratings are etched into semiconductor substrates to make Distributed Feedback (DFB) lasers.

Replicated gratings are generally replicated with polymer materials. In many cases, it is desirable to combine the grating with a bulk optical element such as a prism. To form a combined grating and prism or “grism”, a grating may typically be adhered onto a glass prism using a polymer adhesive.

Although polymer materials are useful in replicated gratings or in adhering gratings to bulk optical elements such as prisms, polymer materials generally may not favorably meet the stringent environmental specifications required for DWDM and other applications. Furthermore, the lifetime transparency of polymer materials may be questionable in applications where an optical signal must be transmitted through the polymer material.

### SUMMARY OF INVENTION

The invention relates to bulk optical elements incorporating gratings and to methods and processes for producing such elements and to methods and processes for producing such elements, and particularly to bulk optical elements, such as prism elements, incorporating gratings, and to methods and processes for producing bulk optical elements incorporating gratings, desirably by a combination of both an etching process and a direct bonding process.

According to an embodiment of the invention, a bulk optical element incorporating a grating is formed by providing a planar optical substrate, providing a bulk optical material, etching a desired optical profile into a surface of said planar optical substrate, and direct bonding said planar optical substrate to said bulk optical material. According to another embodiment, the direct bonding involves chemical bonding, desirably including contacting opposing surfaces to be bonded with a solution having a pH greater than about 8, and then placing the surfaces in contact. According to a further embodiment, etching a desired optical profile includes etching a grating structure, and may include forming a mask on the planar optical substrate and performing a reactive ion etch of the planar optical substrate.

In yet another embodiment, the planar optical substrate employed may include an etch-stop layer at a desired depth below a surface to be etched. The etch depth achieved when etching the desired optical profile may then be controlled by etching down to said etch-stop layer.

According to further embodiments, chemical bonding may include contacting the surfaces to be bonded with an acidic solution prior to the step of contacting with a solution having a pH greater than about 8. The chemical bonding process may further include aqueous rinsing of the surfaces after the step of contacting with an acidic solution and before the step of contacting with a solution having a pH greater than about 8. The chemical bonding process may further include, after placing the surfaces to be bonded in contact, heating the surfaces to a temperature below the softening point of both the substrate and the bulk material. The surfaces are desirably heated to a temperature of less than about 300° C., most desirably to less than about 200° C.

A further embodiment of the invention includes providing a silicon-containing planar optical substrate and providing silicon-containing bulk optical material, etching an optical profile into a surface of the substrate, and chemically bonding a surface of the planar optical substrate to a surface of the bulk optical material by providing termination groups selected from the group including ═Si—(OH)₂, —Si—(OH)₃, and —O—Si—(OH)₃, and combinations thereof on the surface of said planar optical substrate and the surface of said bulk optical material and then placing the surface of said planar optical substrate and the surface of said bulk optical material in contact. In a desirable embodiment, the bulk optical material is in the form of a prism and the optical profile is a grating structure. According to another embodiment, the planar optical substrate may include an etch-stop material to uniformly define the depth of the etch process.

Another embodiment of the invention includes providing an optical substrate having a uniform thickness, providing an optical bulk material having non-uniform thickness and etching multiple copies of a desired an optical profile into a surface of said optical substrate. Each of the multiple copies of the profile are then tested for desired performance, and acceptable copies are separated acceptable from unacceptable copies dicing said substrate and sorting the copies. An acceptable copy of the optical profile is then chemically bonded to the optical bulk material.

The method of the present invention is suitable for porducing prisms or other bulk optical elements useful for simultaneously multiplexing or demultiplexing multiple wavelength channels of an optical communications signal. Creating a grating structure on a planar, wafer-shaped, or uniform thickness substrate allows for efficient and reliable production of acceptable grating structures. Direct bonding the resulting grating structure to a prism or other bulk optical element avoids the need for adhesives or coatings at the bulk material/substrate interface by forming an optically transparent bond. The preferred chemical bonding process provides bond strengths on the order of the strength of bonded materials themselves.

Additional advantages of the invention will be set forth in the following detailed description. It is to be understood that both the foregoing general description and the following detailed description are exemplary and are intended to provide further explanation of the invention as claimed.

### BRIEF DESCRIPTION OF THE DRAWINGS

FIG. 1 is a cross sectional diagram of a bulk optical element in the form of a prism;

FIG. 2 is a cross sectional diagram of the prism of FIG. 1 with a layer of mask material deposited thereon;

FIG. 3 is a cross sectional diagram of the prism of FIG. 2 including a patterned layer of mask material forming a mask.

FIG. 4 is a cross sectional diagram of the prism of FIG. 3 after an etch process has been performed;

FIG. 5 is a cross sectional diagram of the prism of FIG. 4 after removal of the mask material of FIG. 4.

FIGS. 6A-6E are cross-sectional diagrams of a planar or wafer-shaped substrate showing the effects of an etching process similar to that of FIGS. 1-5 on the planar or wafer-shaped substrate.

FIGS. 7A and 7B are cross-sectional diagrams of a planar or wafer-shaped substrate including an etch stop, and showing the effects of an etching process similar to that of FIGS. 6A-6E.

FIG. 8 is a diagrammatic plan view of a planar or wafer-shaped substrate having multiple grating structures formed thereon.

FIG. 9A-9D are cross-sectional diagrams showing the effects of a direct bonding process for bonding a grating and a bulk optical element in the form of a prism.

FIG. 10 is a diagram of termination groups on the surface of a silica-containing article according to a preferred method of direct bonding useful in the present invention;

FIG. 11a is a diagram of adsorbed water molecules and adsorbed hydroxyl groups on opposing surfaces after being brought into contact at room temperature;

FIG. 11b is a diagram of termination groups on the surfaces shown in FIG. 11a after the surfaces have been heated to drive off adsorbed water molecules and hydroxyl groups;

FIG. 11c is a diagram of termination groups on the surfaces shown in FIGS. 11a and 11b after the adsorbed hydroxyl groups have been removed; and

FIG. 12 is flow chart of process steps according to one embodiment of the preferred direct bonding method of the present invention.

### DETAILED DESCRIPTION

According to one embodiment of the present invention, a grating structure may be formed directly into a bulk material of a prism. The grating structure may then be coated with a reflective dielectric, metal, or metallic layer. The reflective layer may then be coated with one or more protective layers. The bulk material of the prism may be any suitable optical material, including but not limited to fused silica, any of various optical glasses, crystals such as silicon or germanium, and the like. Particularly desirable materials may be fused silica for its chemical and mechanical stability. Silicon and germanium, as high index materials transparent at optical communications frequencies, are desirable for achieving especially high dispersion.

The bulk prism is desirably etched with a grating pattern by an etch processes such as reactive ion etching (RIE) employing a mask.

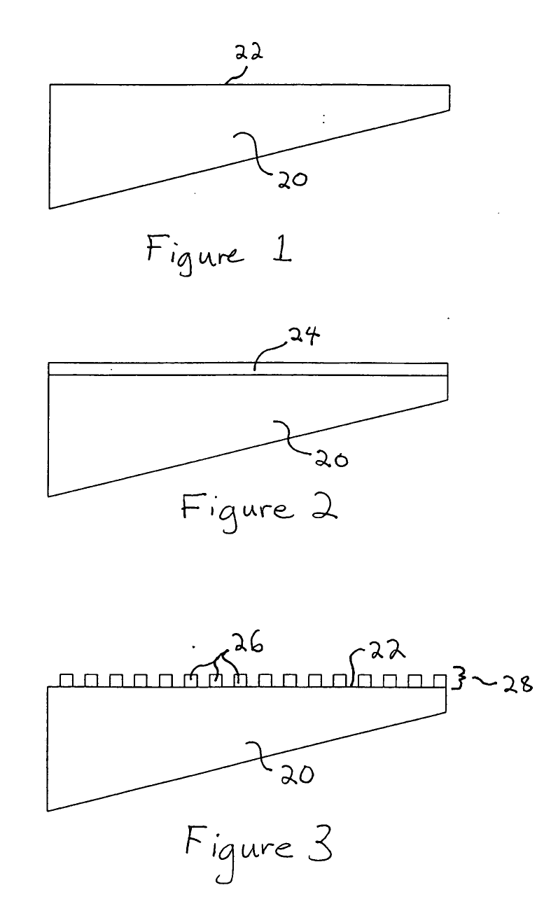

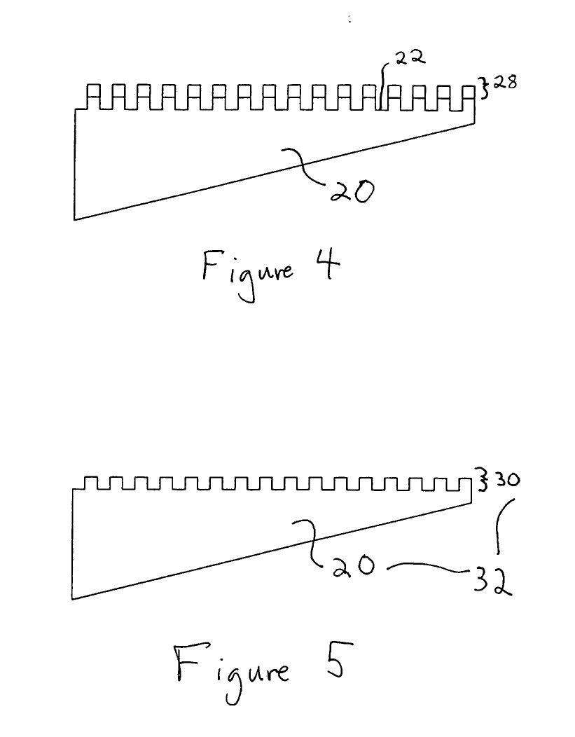

An exemplary bulk prism 20, including a surface 22, is shown in cross section in FIG. 1. A mask material 24, such as a photoresist, is deposited on surface 22, as shown in FIG. 2. Portions of the mask material are removed, such as by exposure and development of photoresist, leaving a mask 28 on the surface 22 formed of remaining portions 26 of the mask material, as shown in FIG. 3. The pattern of the mask 28 is arranged according to the desired features of a grating structure to be etched into the surface 22.

The exposed portions of the surface 22 of the prism 20 are then etched, such as by bombardment with reactive ions in a reactive ion etching (RIE) process. The surface 22 is thereby etched in the pattern of the mask 28, as shown in FIG. 4. The remaining portions of the mask material are then removed from the surface 22, such as by stripping of photoresist, leaving a bulk optical element, the bulk prism 20 in this case, with a grating structure 30 formed integrally therein, thus forming a combined grating and prism or “grism”. The grating structure 30 may then be coated with a reflective layer, such as by sputtering or evaporative deposition of a metal or dielectric reflective layer, if desired.

Forming the grating directly from the bulk optical material of the prism, as according to this embodiment of the invention, avoids the use of polymer for the grating as in a typical replicated grating. Forming the grating directly from the bulk optical material of the prism also eliminates the need to attach the grating to the prism. Forming the grating in the bulk material of the prism thus avoids polymer in the optical path, both in the optical material of the grating and in the adhesive (by the lack thereof). Further, no optical surfaces separate the prism and the grating, avoiding the need for special coatings or other techniques to prevent undesired reflections or other losses at the prism/grating interface.

Despite these significant advantages, applicants have noted certain difficulties in forming gratings directly in the bulk material of a prism or other bulk optical element, as according to this embodiment of the invention. The expense associated with an improper or out-of-spec etch is high, due to the loss of material and processing time and cost represented in the bulk prism. Further, etch processes applied to surfaces of bulk materials can be difficult to control, and can be expensive to equip and maintain.

For example, spin coating is a commonly used, easily controlled method for applying photoresist. But a prism or similar structure is mechanically difficult to spin due to its bulk and non-uniform shape. Further, spin-coating typically achieves uniform thickness resist only on flat, circular surfaces, or within an inscribed circle on non-circular surfaces, making it difficult or impossible to spin-coat a uniform thickness of resist on a rectangular prism face. Resist of non-uniform thickness causes non-uniform etching.

As further example, the RIE process employs a potential difference to accelerate ions toward the substrate to be etched. Thicker substrates (such as prisms) can take up a significant volume and length within an etch chamber, shortening the distance through which the reactive ions are accelerated, thereby reducing the energy of the ions arriving at the substrate and dramatically lengthening etch times for a given etch chamber design.

Further, in typical RIE equipment, the height of the substrate that can be etched will be limited by the chamber height, and, in the case of higher-throughput load-locked systems, by the height of the slot joining the loading chamber to the etching chamber. Therefore certain etching equipment may be limited to processing substrates that are less than 0.5 inches in height. Also, in the case of a prism or any other substrate that has slanted sides that extend past the top of the substrate, the substrates cannot be placed one against each other to fill 100% of the etch surface available. The full area of the RIE machine's electrode is not utilized, and the RIE's cycle time is thus not efficiently utilized. A thicker substrate is also less easily cooled by a cooled electrode or susceptor, further preventing high etch rates.

Accordingly, significant cost and performance advantages are realized by etching thin planar substrates having wafer geometry. Wafers can be processed (cleaned, resist-coated, exposed, developed, and etched) with standard semiconductor processing equipment. The ready availability masking and etch equipment for the semiconductor industry is an important advantage. The geometrical symmetries of the wafer shape are also significant. Wafers are circular in shape, and tend to be thin (<1 mm). Since wafers are circular, spin-coating is the typical technique used to coat a photoresist film onto the surface. Since wafers are thin, electrode or susceptor cooling can more adequately cool the surface to be etched, allowing higher etch rates in an RIE or similar process. For patterning applications that require resist coating, patterning of the resist, and/or subsequent etching, the substrate of preference is a wafer.

According to another embodiment of the present invention, a grism or other bulk optical element incorporating a grating is produced so as to provide one or more of the above advantages of producing the grating on a wafer-shaped substrate, but without the typically accompanying disadvantage(s) of polymer adhesives and/or optical surfaces between the prism or other bulk element and the grating joined to it. This is achieved by etching the grating into a wafer substrate compatible with the bulk material of the prism, then direct-bonding a surface of the grating substrate to a surface of the prism. Fused silica is a particularly suitable material for both prism and grating. Silicon is also particularly suitable, especially for high dispersion.

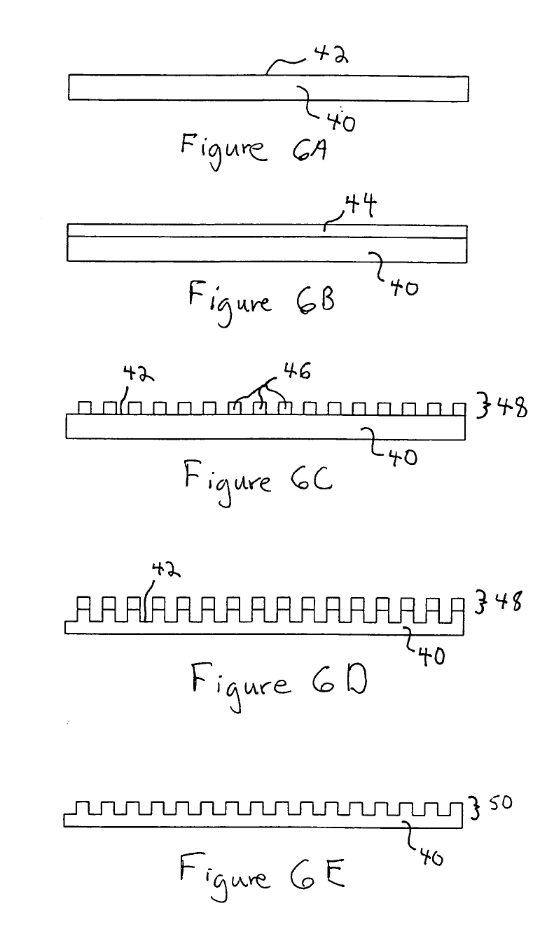

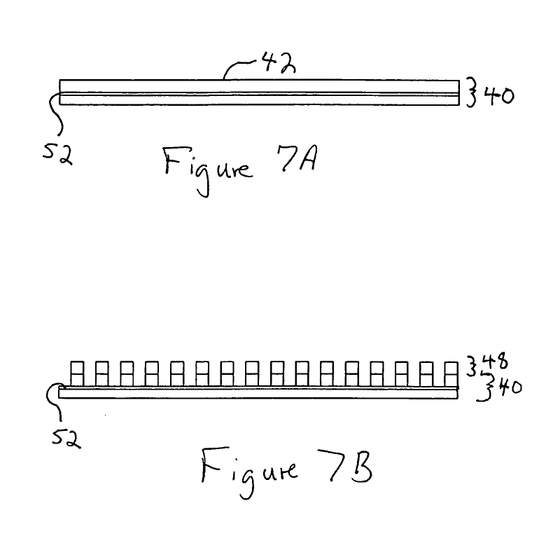

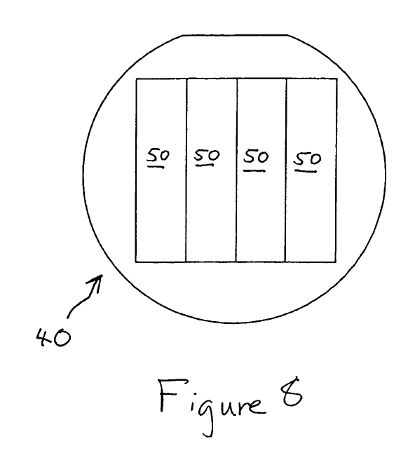

Etching to form a grating structure on a planar substrate may be performed similarly to etching of the bulk prism described above. An exemplary planar or wafer-shaped substrate 40, including a surface 42, is shown in cross section in FIG. 6A. A mask material 44, such as a photoresist, is deposited on the surface 42, as shown in FIG. 6B. Portions of the mask material are removed, such as by exposure and development of photoresist, leaving a mask 48 on the surface 42 formed of remaining portions 46 of the mask material, as shown in FIG. 6C. The pattern of the mask 48 is arranged according to the desired features of a grating structure to be etched into the surface 42.

The exposed portions of the surface 42 of the planar substrate 40 are then etched, such as by an RIE process. The surface 42 is thereby etched in the pattern of the mask 48, as shown in FIG. 6D. The remaining portions of the mask material are then removed from the surface 42, such as by stripping of photoresist, leaving the planar substrate 40 with a grating structure 50 formed integrally therein, as shown in FIG. 6E.

Etching a grating in fused silica or in silicon, germanium, or other materials may also include the use of an “etch stop,” a layer of material that is less easily etched by the selected etch process chemistry. This is illustrated, for example, in FIGS. 7A and 7B. As shown in FIG. 7A, the planar substrate 40 may include a layer of etch-resistant material 52. The layer 52 is located below the surface 42 at the desired etch depth. When an etch process such as an RIE process is performed using a mask 48, the layer 52 tends to stop the etch process at the layer 52 as illustrated in FIG. 7B, providing more uniform etch depth across the surface 42 of the substrate 40. With the use of an etch stop, effective etch uniformity errors can be 0.1% or tighter across an entire wafer-sized substrate.

Examples of etch-resistant materials, relative to fused silica, are scandia (Sc₂₀₃) and hafnia (HfO₂), which etches at rates that are 10× and 100× slower, respectively, than fused silica. A layer of very thin metal, such as Al, Cr, etc., that does not etch in a flourine RIE environment, may also be used. Ge and Si also etch at lesser rates than fused silica, so these also may be used. Etch-resistant materials relative to silicon include silica and many others.

As shown in FIG. 8, a plan view of a wafer-shaped substrate 40, The etch process can define multiple grating structures 50 on a single substrate, which may then be separated or diced into individual gratings. Testing and/or measurement of grating performance may be performed on each individual grating at this point, so that the yields of finished bulk optical devices are maximized.

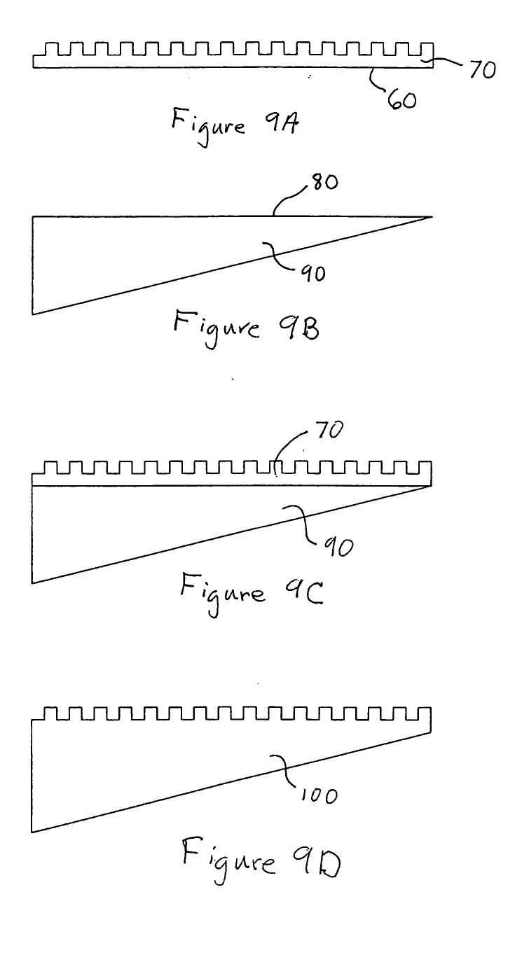

Bulk optical elements such as grisms incorporating the gratings are then formed by direct bonding an etched grating to a prism. In overview, direct bonding is accomplished by properly preparing a surface 60 of an individual grating 70, as shown for example in FIG. 9A, and a corresponding surface 80 of a bulk optical element such as a prism 90, as shown for example in FIG. 9B. Surface preparation may include, in this general order, polishing, cleaning with detergent, contacting with a low pH substance, and contacting with a high pH substance. The properly prepared surfaces 60 and 80 are then brought into optical contact as represented in FIG. 9C. Moderate heating to less than the softening or transition temperatures of the materials, is then applied. Pressure may also be applied, on the order of about 1 pound per square inch (psi), more preferably about 2 psi. The direct bonding process results in the formation of a bond with as great strength as the bonded material itself, without deformation of the optical surfaces due to softening from excess heating. Further, particularly if the materials of grating 70 and prism 90 are identical, the direct bonding process leaves no residual optical interface between the prism 90 and the grating 70, such that the two structures become optically one, as represented by grism 100 of FIG. 9D.

The grism of FIG. 9D provides all the advantages of the grism of FIG. 5, but without the above-discussed disadvantages inherent in etching a bulk, non-uniform substrate. The use of etching followed by direct bonding thus enables low-cost production of high-quality bulk optical components comprising gratings.

The direct bonding process of the present invention will now be reviewed in relative detail. Even more specific details on direct bonding of optical components may be found in copending U.S. patent application Ser. No. 10/035,358 filed Oct. 26, 2001 and Ser. No. 10/255,777 filed Sep. 25, 2002 both entitled “Direct Bonding of Optical Components,” commonly assigned to the assignee of the present patent application and naming Robert Sabia, John F. Filhaber, Clearence E. Ford, and Jackson P. Trentleman as inventors, both being hereby incorporated by reference in their entirety.

As used herein, the terms “direct bonding” and “direct bond” means that bonding between two surfaces is achieved at the atomic or molecular level, no additional material exists between the bonding surfaces such as adhesives, and the surfaces are bonded without the assistance of fusion of the surfaces by heating. As used herein, the terms “fusion” or “fusion bonding” refers to processes that involve heating the bonding surfaces and/or the material adjacent the bonding surfaces to the softening or deformation temperature of the articles bonded. Direct bonding does not involve the use of adhesives or fusion bonding to bond optical components. Direct bonding forms a bond between the surfaces without high temperatures that soften the material to the point of deformation or the softening point (and which typically results in an interface that is not optically clear). Direct bonding provides an impermeable, optically clear seal, meaning that there is essentially zero distortion of light passing between the interface of the bonded surfaces. The formation of a direct bond between two surfaces allows for an impermeable seal that has the same inherent physical properties as the bulk materials being bonded.

One embodiment of a direct bonding process that may be utilized according to the present invention involves chemical bonding of materials containing silicon, in which reactive termination groups are provided on opposing surfaces of the articles to be bonded. The surfaces are then placed in contact. According to another embodiment or aspect, the temperature of the opposing surfaces may be maintained at a temparature below about 300° C., desirably below about 200° C. during the contacting step, resulting in high bond strength and seal integrity while preserving the optical characteristics of the articles being bonded. No adhesives, high temperature treatment or caustic hydrofluoric acid treatments are required prior to bonding the opposing surfaces.

According to another embodiment of the chemical bonding process that may be used in the invention, the step of providing functional groups includes contacting opposing surfaces of the articles to be bonded with a high pH solution. As used herein, the term high pH means a solution having a pH of at least about 8. Suitable high pH solutions include hydroxide-based solutions such as potassium hydroxide, sodium hydroxide and ammonium hydroxide. In another embodiment, the method may further include cleaning the opposing surfaces with a detergent and contacting the opposing surfaces with an acid. In still another embodiment, the opposing surfaces may also be ground and polished prior to contacting the surfaces. According to this embodiment, it may be desirable to provide a bonding surface having a flatness less than 1 micron and a roughness of less than 2.0 nm RMS, preferably less than 1.5 nm RMS.

In a preferred embodiment of the chemical bonding process, the pH of the high pH solution is greater than 8, but less than 14. In a highly preferred embodiment, the step of contacting the opposing surfaces with the high pH solution is performed after the step of contacting the opposing surfaces with the acid. Suitable acids for this step may include hydrochloric acid, nitric acid and sulfuric acid. According to still another embodiment, the opposing surfaces are rinsed with water and placed in contact without drying the opposing surfaces. In a preferred embodiment, pressure of at least one pound per square inch, more preferably, at least two pounds per square inch, is applied to the opposing surfaces during the step of contacting the opposing surfaces. In another embodiment, it may be desirable to dry the surfaces to remove adsorbed water molecules and hydroxyl groups and to draw a slight vacuum, for example, about 10-3 millibar, to assist in the prevention of an air gap between the surfaces. The method provides a simple, low temperature, and inexpensive bonding method that provides a high bond strength. Bonding can occur at temperatures lower than 300° C., and in some cases lower than 100° C. The resulting seal is complete, impermeable and does not include an air gap.

Details on the bond strength and additional information on a preferred embodiment of chemically bonding surfaces of articles containing silicon may be found in copending U.S. patent application Ser. No. 10/035,564 filed Oct. 26, 2001 and Ser. No. 10/255,926, filed Sep. 25, 2002 and each entitled “Direct Bonding of Articles Containing Silicon,” commonly assigned to the assignee of the present patent application and naming Robert Sabia as inventor, both being hereby incorporated by reference. As further described therein, it was found by the inventors that cleaning and low pH treatment alone did not result in complete bonds that could be repeatably produced of certain silicon-containing articles. In several trials, only a portion of interfaces between articles successfully bonded. However, repeatable and complete bonds could be provided by contacting the bonding surfaces with a high pH solution.

Thus, according to one desirable embodiment of chemical bonding, the surfaces to be bonded are contacted with a high pH solution, rinsed, pressed into contact, and gradually heated to a desired temperature. The actual temperature will depend on a variety of factors, including, but not limited to the materials bonded, CTE mismatch between materials and the presence of polymers. The temperature treatment must be high enough and for a time sufficient to drive off the adsorbed water molecules and adsorbed hydroxyl groups at the bonding interface to allow for the formation of chemical bonds. This can be done at any temperature below the softening point of the glass while preventing loss of geometrical tolerances. For example, for high purity fused silica, this temperature can be as high as approximately 1000° C., for Pyrex®, as high as about 650° C., for Polarcor™ (a polarizing glass available from the assignee of the present invention), as high as about 500° C. For applications where the system includes materials such as polymeric adhesives and coatings (away from the directly bonded surfaces), the required temperature is below that which promotes degradation or embrittlement of the polymer (typically 150-200° C., usually a maximum of around 250° C., but preferably less than 150° C.). In cases where a low temperature frit is used to seal and/or adhere components (away from the directly bonded surfaces), the temperature used for direct bonding may need to be lower, and will depend upon the melting temperature of the frit.

For applications that include sealing materials with significantly different CTE values, sealing must be performed at a low enough temperature (typically less than 100° C.) such that the sealed part will not exhibit high stress when cooled to room temperature. To enhance bonding, it is highly preferred that the surfaces are flat, as determined by performing a preliminary cleaning and pressing of the dried samples into contact. Resulting interference fringes can be acquired according to techniques known in the art and interpreted to determine matching flatness. An optical flat or interferometer can also be used to evaluate individual surface flatness. Also, interference fringes between two mating surfaces prior to bonding can be used to observe and measure conforming flatness.

Desirably, the bonding process includes ensuring each surface to be bonded has an appropriate flatness, by machining or other means. Desired flatness levels are generally less than about 5 microns, particularly less than about 1 micron, with roughness levels of generally less than about 2.0 nm RMS, particularly less than about 1.5 nm RMS. In general, it is desirable to have less than about 1 micron of conformation between the bonding surfaces, however, less conformance is acceptable if a higher amount of pressure is applied to the bonding surfaces.

After suitable polishing as required, each surface is desirably cleaned with an appropriate cleaning solution such as a detergent, then soaked in a low pH acidic solution, and then soaked in a high pH basic solution to generate a clean surface with silicic acid-like terminated surface groups. Such surface Such surface groups include ≡Si—OH, and more reactive groups including ═Si—(OH)₂, —Si—(OH)₃ and —O—Si—(OH)₃. In preferred embodiments, ═Si—(OH)₂, —Si—(OH)₃ and —O—Si—(OH)₃) account for the majority of the terminated surface groups. In certain desirable embodiments of the chemical bonding process, the surfaces are assembled without drying. However, in some embodiments of the chemical bonding process it may be acceptable to moderately dry the bonding surfaces to remove adsorbed water molecules, especially when using a low vacuum (e.g., about 10-3 millibar) to assist in sealing the bonding surfaces so as to avoid an air gap. A low to moderate load (at least about one PSI) may then be applied as the surfaces are heated to less than about 300° C., for example, to between about 100° C. and about 200° C., so that adsorbed water evaporates and silicic acid-like surface groups condense to form a covalently-bonded interface.

Without limitation on the scope of chemical bonding processes, the following describes the effects of a desirable embodiment of chemical bonding as presently understood:

Contacting a clean, hydroxyl-terminated silicon-containing surface with a high pH solution (e.g. pH greater than about 8, or a pH greater than about 9) causes the surface to slowly dissolve, forming silicate species, such as, for example, SiO₂(OH)₂²⁻, SiO(OH)₃⁻, etc. in solution. Likewise, the active sites on the reacting surface are terminated by similar ≡Si—O⁻, ═Si—(O⁻)₂, —Si—(O⁻)₃, and —O—Si—(O⁻)₃ groups. By lowering the pH of the system (e.g., rinsing in pH neutral DI-water), the surface termination groups convert to —Si—OH, ═Si—(OH)₂, —Si—(OH)₃, and —O—Si—(OH)₃ termination groups (i.e., silicic acid-like surface groups, see FIG. 10 for graphical representation). Preferably, the majority of the terminations include, ═Si—(OH)₂, —Si—(OH)₃, and —O—Si—(OH)₃.

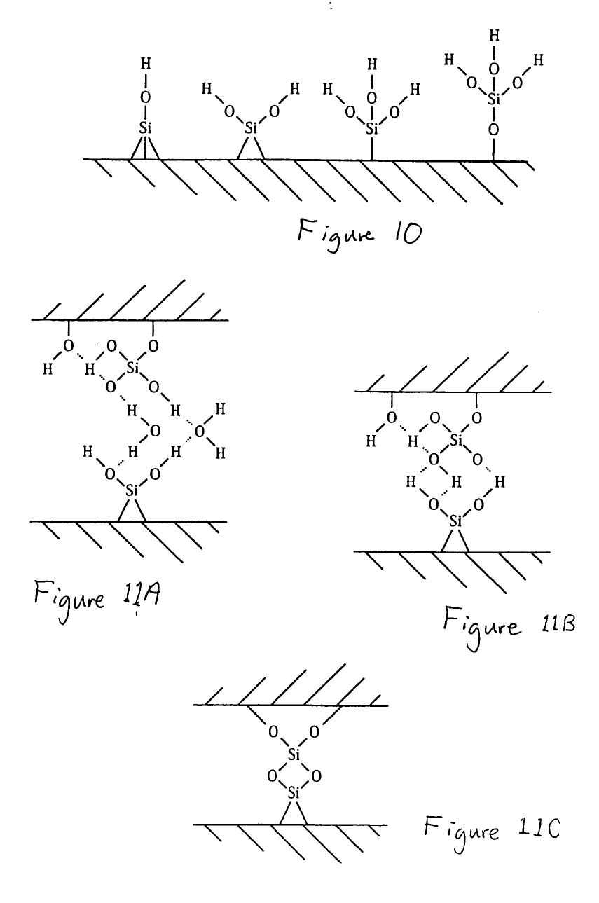

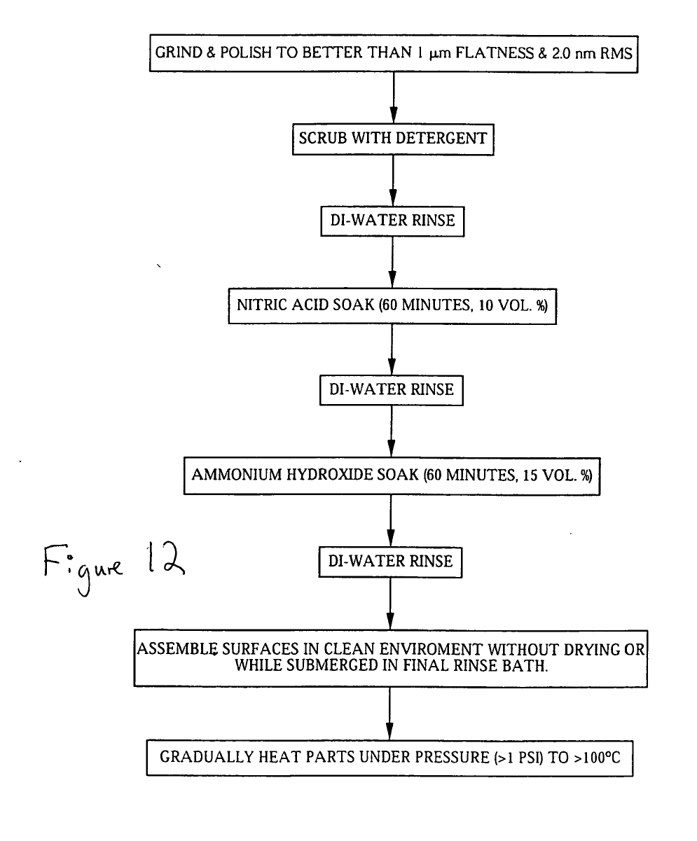

After surfaces with Si—O—H termination groups are generated, water molecules spontaneously adsorb from an aqueous solution onto the silicic acid-like termination groups. When two such surfaces are brought into contact, these adsorbed water molecules and hydroxyl groups form similar bonds to both surfaces, thus acting to bridge the surfaces with hydrogen bonds, as shown in FIG. 11A. With moderate heating, the adsorbed water molecules and hydroxyl groups are driven off, and hydrogen bonding exists between the silicic acid-like termination groups on each surface (see FIG. 11B). With further and/or higher temperature heating, these silicic acid-like surface termination groups condense to form covalent bonds between the two surfaces (e.g., ≡Si—O—Si≡), with water as a byproduct (FIG. 11C).

For silicon-containing surfaces having a high percentage of silica, higher temperature heating is not necessarily required to form high strength bonds. For silica systems containing a greater amount of silica, heating below 300° C. as part of the sealing process is usually sufficient to form a high strength bond. On the other hand, samples that have a lower amount of silica in the glass composition may require heating to higher temperatures to form a satisfactory bond. For example, Pyrex® glass (containing approximately 81% silica) and Polarcor™ (containing approximately 56% silica), which are borosilicate glasses available from Corning Incorporated, Corning, N.Y., may require additional heating to provide sufficient bond strength for applications requiring high bond strength. The degree of heating for different bonding surfaces and glass surfaces will depend in part on the type of surface to be bonded and the desired bond strength for a particular application. As noted above, in systems that include polymeric materials, it is undesirable to heat the surfaces to the point where the polymeric material is damaged.

Compared with bonding systems that utilize only a low pH treatment and rely on hydroxyl terminated surface groups (groups consisting only of —Si—OH), it is believed the present invention provides more robust bonding between silicon-containing articles for several reasons. While not wishing to be bound by theory, it is believed that larger silicic acid-like termination groups allow bonding (both hydrogen and covalent) to occur between surface groups that extend further away from the surface. Larger surface termination groups, such as ═Si—(OH)₂, —Si—(OH)₃, and —O—Si—(OH)₃, extend further from the surface than ≡Si—OH, and these larger groups are more susceptible to steric movement which promotes better bonding between surfaces that include these larger groups. Additionally, each surface can be considerably rougher and still generate bonding due to the length by which the ═Si—(OH)₂, —Si—(OH)₃, and —O—Si—(OH)₃ termination groups extend from the surface. Although termination groups specific to bulk surfaces being bonded can be formed for a variety of glass formers (e.g., SiO₂, B₂O₃) and intermediates (e.g., Al₂O₃), application to sealing of glass compositions that have significantly higher alkali and alkaline earth concentrations is expected to be difficult. For these types of glass compositions, high pH treatment to form surface termination groups specific to each constituent that extend from the surface (similar to silicic acid-like termination groups for silica surfaces) is expected to improve bonding performance between the surfaces.

Silicic acid-like termination groups are also more reactive than only —Si—OH groups. In addition, the process of removing adsorbed water molecules and hydroxyl groups to promote hydrogen bonding between —Si—OH and the more reactive ═Si—(OH)₂, —Si—(OH)₃, and —O—Si—(OH)₃ surface groups and condensation of said groups can occur at lower temperatures (i.e., below 100° C.) or in shorter time periods at equivalent temperatures compared to hydroxyl-terminated surfaces sites. It is also believed that this process can be applied at lower pressures to attain equivalent or superior strengths compared to low pH bonding procedures that have been found to require higher pressure.

A flow chart of the process steps of one embodiment of chemical bonding are shown in FIG. 12. According to this embodiment, the bonding surface of an article can be provided by grinding the bonding surface flat, lapping to remove grinding damage while maintaining flatness, and polishing to produce an optically clear surface without subsurface damage. The surfaces to be bonded are then cleaned using a detergent, soaked in a strong acid such as nitric acid to remove adsorbed hydrocarbons and dissolved rare-earth contaminants (e.g., cerium oxide from the polishing step), and finally contacted with a high pH alkali solution such as ammonium hydroxide. The surfaces are then brought into contact and gradually heated to approximately 200° C. for an extended period of time before cooling and inspecting the seal. The bond interface is denoted by a lack of interference fringes. If fringes are observed, they will appear around the bonded area, indicating surface separation due to non-conformity of the surfaces.

As noted above, for certain surface compositions, it may be desirable for additional heat treatment or annealing after placing the surfaces in contact. Whether or not an annealing treatment is possible or practical depends on the presence of low temperature constituents of the component or package being bonded (e.g., presence of low-temperature softening or degrading materials such as adhesives and coatings away from the bond interface). It must also be considered that excessive heating of certain materials may result in a loss of dimensional tolerances.

Another factor to consider during bonding of glass surfaces is the solubility behavior of the material being prepared for bonding. During cleaning, solution pH may create heterogeneous etching rates between the various glass constituents. This can lead to loss of surface quality in terms of increased roughness or generation of a pitted surface. For example, the ammonium hydroxide soak used to hydrate the glass surface has a pH between 12-13. This is high enough to cause silica in a glass surface to slowly dissolve. Extended soaking time can lead to a roughening of the surface if other constituents of the glass dissolve either faster or slower. Other suitable high pH solutions include hydroxide-based solutions such as potassium hydroxide and sodium hydroxide. Ammonium hydroxide is a weak base, and a highly concentrated solution of ammonium hydroxide will not exceed pH of approximately 13. Comparatively, sodium and potassium hydroxides are strong bases and can easily exceed pH 14, with IM concentration for a strong base=pH 14. A 1 M concentration of KOH is typically used to clean laboratory glassware. This solution is effective in removing contaminants by dissolving the glass surface around and under the contaminant and thus allowing the contaminant to disperse in solution. This level of highly concentrated solution results in an aggressive attack of a glass surface with a high dissolution rate, and thus may not be desirable for the present invention. Alternatively, a pH such as 12-13 will thermodynamically allow for solubility of a glass surface, however, kinetically this solubility reaction proceeds at a much slower rate than for a pH 14 solution.

Likewise, the nitric acid solution has a pH near 0, and will preferentially etch lead from a lead-silicate glass. Thus, modification of the cleaning protocol might be required in terms of soak time and acid and/or alkali concentration for complex glass compositions, and these modifications can be determined by experimentation for various types of glasses.

(end SP00-301)

Lithium may be used advantageously to reduce the temperatures needed for chemical bonding of materials including borosilicate glasses. This is described in detail in copending U.S. patent application Ser. No. 10/118,780 filed Apr. 8, 2002 entitled, “Direct Bonding Methods Using Lithium,” commonly assigned to the assignee of the present patent application and naming Robert Sabia as inventor, hereby incorporated by reference in its entirety. As explained therein, further experimentation in the area of direct bonding has led to the discovery that bonding can be improved by including lithium in or on the surface of the articles to be bonded, or by incorporating lithium in the composition of the articles to be bonded.

While direct bonding using lithium should not be limited by a particular theory of operation, applicants presently offer the following understanding: Lithium is one of the most mobile ions and readily migrates within a solid materials such as glass at temperatures below 100° C. This behavior is due to the lithium ion's size, charge, and diffusion constant. Migration is a diffusion process, which is generally inconsequential for materials of homogeneous composition where bulk migration of one component does not result in a compositional gradient. In other words, as one lithium ion in a homogeneous material migrates from point A to point B, statistically, another will migrate from point B to point A.

However, by coating a surface with lithium and/or including lithium in or on a surface, a physical compositional gradient is generated, which with heating will allow for bulk diffusion of lithium away from the lithium rich area into the lithium deficient area. When surfaces (one or both) containing lithium are brought into contact and heated, lithium will migrate across the interface from one surface to another, thus generating covalent bonds between the surfaces. If a gradient exists in terms of lithium concentration between the two surfaces, lithium will migrate from the lithium rich surface into the lithium poor surface, mostly without exchange for less mobile ions such as sodium or potassium. If a layer of lithium metal or oxide is placed on one surface prior to contacting the surfaces and heating, lithium will diffuse from the layer into each surface.

For compositions containing between about 50% and 95% silica by weight, the chemical bonding process described above, without the use of lithium, typically yields bond strengths between about 10-30 pounds per square inch, with bond failure typically occurring by delamination. For higher bond strengths, the bonding process can be followed by an annealing cycle to temperatures up to about 600° C., thus converting hydrogen bonds to covalent bonds. Such annealed seals do not fail by delamination, but rather fail by fracture of the bulk glass away from the seal, with fracture strengths typically between about 100-200 pounds per square inch. However, such anneal cycles are not practical for applications when low temperature materials are incorporated into one or both of the structures to be bonded.

Bond strength in Pyrex® and other materials is improved by including lithium in or on at least one of the surfaces prepared for bonding. Lithium can be included in or on the surfaces by various methods. For example, lithium can be exchanged, deposited, or implanted into surfaces prepared for bonding, thus allowing chemical bonding to become directly feasible for applications where glass or other silicon-containing materials otherwise have poor bond strength. Furthermore, inventive glass or silicon-containing compositions may incorporate lithium for specific application where chemical bonding is to be used.

Experiments have confirmed that Pyrex® glass articles will not generate a strong bond without a subsequent anneal up to temperatures exceeding about 400° C. Rather, Pyrex® surfaces sealed at about 200° C. were found to delaminate at loads lower than about 20 pounds per square inch. In comparison, equivalent bonding of high purity fused silica (HPFS™) and Fotoform™ surfaces without a subsequent high temperature anneal resulted in failure by glass fracture above 125 pounds per square inch. While the present invention should not be limited by any particular theory, lithium migration between Fotoform™ surfaces was hypothesized to be the mechanism for stronger bonding over Pyrex® surfaces, because Pyrex® does not contain lithium. Both Fotoform™ and Pyrex® are complex silicate glasses that include large concentrations of alkalis.

According to some embodiments of lithium-enhanced chemical bonding, Pyrex® seal strengths are increased to greater than about 90 PSI by ion exchanging lithium for sodium in the surface of glass articles prior to bonding. The seals do not require a post-bonding anneal to generate higher seal strengths, thus allowing for bonding of complex systems that include polymeric coatings and adhesives that degrade above about 150 to 200° C. Failure occurred by glass fracture rather than by delamination.

Other embodiments of lithium-enhanced chemical bonding involve sealing of lithium-containing glasses or glass-ceramics, where both surfaces contain lithium. Still other embodiments of the invention relate to sealing or bonding of two surfaces where one surface is a lithium-containing glass or glass-ceramic and the other surface does not include lithium.

In other embodiments, sealing or bonding of glass surfaces containing alkalis is achieved by incorporating lithium into the glass surfaces by an ion exchange process. In still other embodiments, lithium can be included in glass surfaces that contain little or no alkali by utilizing lithium-ion implantation. After ion implantation, the surfaces including lithium can be bonded. Other embodiments involve the incorporation of lithium into the manufacturing of novel glass and glass-ceramics for chemical bonding applications.

A desirable exemplary process for lithium-enhanced chemical bonding is as follows: Each surface to be sealed is provided with appropriate flatness, typically by mechanical or chemical/mechanical polishing. Particularly preferred flatness levels are less than about 1 micron and roughness levels of less than about 2.0 nm RMS. After polishing, lithium ions can be exchanged into surfaces containing alkali ions by contacting the surface of with a mixture containing lithium ions. Such a mixture could include a particular lithium salt or mixture of lithium salts. For example, a 1:5 ratio mixture of lithium sulfate and lithium nitrate could be used to soak the surface prepared for bonding. In certain embodiments, it may be desirable to heat the mixture during soaking to a temperature of about 500° C. and to soak the surface for about 16 hours. Thereafter, depending on the roughness of the surface after ion exchange, it may be desirable to re-polish the surface to about 100 nm RMS. After polishing, each surface is preferably cleaned with an appropriate cleaning solution such as a detergent, soaked in a low pH acidic solution such as 10 volume percent nitric acid, rinsed, and soaked in a high pH basic solution such as a 15 volume percent ammonium hydroxide solution to generate a clean surface with silicic acid-like (i.e., —Si—OH, ═Si—(OH)₂, —Si—(OH)₃ and —O—Si—(OH)₃) terminated surface groups. In a preferred embodiment, the surfaces are assembled without drying. A low to moderate load (as low as about 1 PSI) is then applied as the surfaces are heated to less than 300° C., for example, between 100-200° C., so that adsorbed water molecules evaporate and silicic acid-like surface groups condense to form a covalently-bonded interface. Pressure can be applied using various fixturing devices that may include the use of compressed gas or a low vacuum pressure that is not detrimental to polymers. In some embodiments, it may be acceptable to moderately dry the bonding surfaces to remove adsorbed water molecules, especially when using a low vacuum (e.g., about 10-3 millibar) to assist in sealing the bonding surfaces without an air gap.

Ion exchange will occur when lithium diffuses into a silicon-based glass containing other alkali additives. Lithium will diffuse into the surface, while the ion for which lithium is exchanging will more towards the bulk surface. In one experiment lithium (from a lithium nitrate/sulfate mixture) was ion exchanged for sodium in Pyrex® glass at about 500° C. for about 16 hours. Because the surface crazed and therefore degraded past the minimal flatness and roughness required for sealing, the surfaces were re-polished while only removing a shallow depth of material while still ensuring that lithium existed in the re-polished surface. Results for sealing of these samples at a temperature of about 200° C. without a subsequent anneal or heat treatment at a higher temperature showed an increase in seal strength as determined by tensile testing and seal failure by fracture rather than delamination.

Lithium-enhanced chemical bonding is also useful in bonding or sealing of two dissimilar materials that have significantly different coefficients of thermal expansion (CTE). Stress between the two surfaces due to the difference in CTE can and typically does prevent the formation of a strong bond when the surfaces have to be annealed to achieve the bond or seal. The present invention allows the bond or seal to be formed without using high temperatures, more specifically at temperatures below 100° C.

### EXAMPLES 1 AND 2

### Illustrating Chemical Bonding Without Lithium

### EXAMPLE 1

### Bonding of High Purity Fused Silica Surface

Corning product code 7980 HPFS® bars were bonded by the method of FIG. 12 and the bonding between the bars at a temperature of 200° C. was strong enough so that one of the bars failed at 160.9 psi.

### EXAMPLE 2

### Bonding of Polarcor™ Surfaces

Polarcor™ is a borosilicate glass. A proprietary polarization process makes the outer surfaces act as polarizers. Active polarization occurs in the outer 20-50 microns of the glass surface. Polarcor bars were bonded together by the method of FIG. 12 at a bonding temperature of about 200° C. A first set of samples resulted in the bond between the bars delaminating at 45.8 psi. A second set of samples was annealed to about 500° C., and these bars failed in tension at 127.9 psi.

### EXAMPLES

### Illustrating Lithium-Enhanced Bonding

Sample Preparation

For each of the samples listed in Table I below, the surfaces were bonded at a temperature of about 200° C. Prior to sealing of the surfaces, they were polished to less than about 0.5 microns flatness. A detergent such as Microclean CA05 was used to clean the samples, and after a water rinse, the sample was soaked in 10 volume % nitric acid for one hour. The acid-soaked samples were rinsed again with water, and then the samples were soaked in a 15 volume % ammonium hydroxide solution for 60 minutes. The samples were rinsed again, and the bonding surfaces were maintained in a wet condition and bonded under a pressure greater than about one pound per square inch and at a temperature noted above.

The results are shown in Table I below. The table lists fracture behavior of chemically bonded surfaces tested in tension, with all seals generated at 200±5° C. with no subsequent annealing cycle. Strength values given for bonds that failed by glass fracture do not represent the bond strength upper limit, but instead indicate that failure occurred away from the seal interface at the indicated load due to a structural flaw in the bulk material.

TABLE I

| Sealed Surfaces | Bond strength | Fracture Behaviour |
|---|---|---|
| 1 Pyrex ® to Pyrex ® | 16.4 PSI | Delamination |
| 2 Li Implanted Pyrex ® to Li Im- | 92.8 PSI | Glass Fracture |
| planted Pyrex ® | | |
| 3 Fotoform ® to Fotoform ® | 128.8 PSI | Glass Fracture |
| 4 Fotoform ® to Fotoform Opal ® | 204.5 PSI | Glass Fracture |
| 5 Fotoform Opal ® to Fotoform | 151.7 PSI | Glass Fracture |
| Opal ® | | |

Lithium oxide was placed in the surface of the Li Implanted Pyrex® sample by soaking the Pyrex® samples in a solution of lithium sulfate and lithium nitrate (the ratio of lithium sulfate to lithium nitrate was 1:5) at 500° C. for 16 hours. Fotoform®, like Pyrex® is a low silica glass, i.e., a glass that contains less than approximately 80% silica. Fotoform® contains approximately 9.7% lithium oxide, and Pyrex® does not contain any lithium oxide. Fotoform Opal® is a Fotoform® glass that has been cerammed to a glass-ceramic. The results in Table I show that all of the samples that contained lithium had a bond strength that was higher than the glass fracture strength of the bulk material. The Pyrex® samples, which did not have lithium in the surface or the bulk of the glass, failed at the seal by delamination. These results indicate that including lithium in at least a surface portion of a glass or glass-ceramic article will improved bond strength between the articles. Bond strength can be improved by including lithium in the surface by implantation of lithium or by incorporating lithium into to the bulk composition of the glass or glass ceramic article.

The use of lithium to improve bond strength has several advantages. Lithium can diffuse at temperatures below 100° C., thus promoting a low-temperature bonding processes. Experimental results did not indicate that this low temperature effect occurred with any other alkali ion. Another advantage of the present invention is that lithium in small amounts will not interfere with optical properties of glasses. Therefore, using lithium to generate a seal or bond that is part of an optical path is not detrimental to optical performance. Still another advantage of some embodiments of the present invention is that lithium can be ion exchanged or implanted into virtually any silica-based glass composition. Additionally, lithium can be used to promote and/or improve bonding between materials with significantly different coefficient of thermal expansion (CTE) values by promoting sealing at lower-than-normal temperatures (below about 100° C. in less than 24 hours). Lithium can be used to promote low temperature bonding between anti-reflectance coatings on materials with significantly different RI.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

What is claimed is:

1. A process for forming an optical element, the process comprising:
providing a planar optical substrate;
providing a bulk optical material;
etching an optical profile into a surface of said planar optical substrate; and
chemically bonding said planar optical substrate to said bulk optical material, said chemically bonding including the steps of
contacting opposing surfaces to be bonded with a solution having a pH greater than about 8, and
placing said surfaces in contact.

2. The process of claim 1 wherein the step of etching an optical profile comprises the steps of forming a mask on said optical substrate and performing a reactive ion etch of said optical substrate.

3. The process of claim 2 wherein the step of providing a planar optical substrate comprises providing a planar optical substrate including an etch-stop layer at a desired depth below a surface to be etched.

4. The process of claim 3 wherein the step of etching an optical profile comprises the steps of forming a mask on the surface to be etched of the optical substrate and performing a reactive ion etch of said surface, down to said etch-stop layer.

5. The process of claim 1 wherein the step of chemically bonding further includes the step of contacting said surfaces with an acidic solution prior to the step of contacting with a solution having a pH greater than about 8.

6. The process of claim 5 wherein the step of chemically bonding further comprises aqueous rinsing of said surfaces after the step of contacting with an acidic solution and before the step of contacting with a solution having a pH greater than about 8.

7. The process of claim 1 wherein the step of chemically bonding further comprises, after the step of placing said surfaces in contact, the step of heating said surfaces to a temperature below the softening point of both said substrate and said bulk material.

8. The process of claim 7 wherein the step of heating said surfaces comprises heating said surfaces to a temperature of less than about 300° C.

9. The process of claim 7 wherein the step of heating said surfaces comprises heating said surfaces to a temperature of less than about 200° C.

10. The process of claim 1 wherein the step of providing a planar optical substrate includes providing a planar optical substrate including lithium therein or thereon.

11. The process of claim 1 wherein the step of providing a bulk optical material includes providing a planar optical substrate including lithium therein or thereon.

12. The process of claim 1 wherein the step of chemically bonding further includes the step of providing lithium in or on one of said opposing surfaces.

13. A process for forming a grism, the process comprising:
providing a planar optical substrate;
providing a bulk optical material in the form of a prism;
etching an optical profile into a surface of said planar optical substrate; and
chemically bonding said planar optical substrate to said prism, said chemically bonding including the steps of.
contacting at least a surface of said prism and a surface of said planar substrate with an acidic solution,
contacting at least said surface of said prism and said surface of said planar substrate with a solution having a pH greater than 8, and
placing said surface of said prism and said surface of said planar substrate in contact.

14. The process of claim 13 wherein the step of etching an optical profile comprises the steps of forming a mask on said optical substrate and performing a reactive ion etch of said optical substrate.

15. The process of claim 14 wherein the step of providing a planar optical substrate comprises providing a planar optical substrate including an etch-stop layer at a desired depth below a surface to be etched.

16. The process of claim 15 wherein the step of etching an optical profile comprises the steps of forming a mask on the surface to be etched of the optical substrate and performing a reactive ion etch of said surface, down to said etch-stop layer.

17. The process of claim 13 wherein the step of chemically bonding further comprises aqueous rinsing of said surfaces after the step of contacting with an acidic solution and before the step of contacting with a solution having a pH greater than about 8.

18. The process of claim 13 wherein the step of chemically bonding further comprises, after the step of placing said surfaces in contact, the step of heating said surfaces to a temperature below the softening point of both the prism and the planar substrate.

19. The process of claim 18 wherein the step of heating said surfaces comprises heating said surfaces to a temperature of less than about 300° C.

20. The process of claim 18 wherein the step of heating said surfaces comprises heating said surfaces to a temperature of less than about 200° C.

21. A process for forming an optical element, the process comprising:
providing a silicon-containing planar optical substrate;
providing silicon-containing bulk optical material;
etching an optical profile into a surface of said substrate; and
chemically bonding a surface of said planar optical substrate to a surface of said bulk optical material, said bonding including
providing termination groups selected from the group including ═Si—(OH)₂, —Si—(OH)₃, and —O—Si—(OH)₃, and combinations thereof on the surface of said planar optical substrate and the surface of said bulk optical material and
placing the surface of said planar optical substrate and the surface of said bulk optical material in contact.

22. A process for forming a grism, the process comprising:
providing a silicon-containing planar optical substrate;
providing silicon-containing bulk optical material in the form of a prism;
etching an optical profile into a surface of said substrate; and
chemically bonding a surface of said planar optical substrate to a surface of said prism, said bonding including
providing termination groups selected from the group including ═Si—(OH)₂, —Si—(OH)₃, and —O—Si—(OH)₃, and combinations thereof on the surface of said planar optical substrate and the surface of said bulk optical material and
placing the surface of said planar optical substrate and the surface of said bulk optical material in contact.

23. A process for forming an grism, the process comprising:
providing a planar optical substrate including an etch stop material;
providing a bulk optical material in the form of a prism;
etching to said etch stop so as to form an optical profile into a surface of said planar optical substrate; and
chemically bonding said planar optical substrate to said prism, said chemically bonding including the steps of.
contacting at least a surface of said prism and a surface of said planar substrate with an acidic solution,
contacting at least said surface of said prism and said surface of said planar substrate with a solution having a pH greater than 8, and
placing said surface of said prism and said surface of said planar substrate in contact.

24. A process for forming an optical element, the process comprising:
providing a thin optical substrate;
providing a bulk optical material thicker than said thin optical substrate;
etching an optical profile into a surface of said thin optical substrate; and
chemically bonding said thin optical substrate to said bulk optical material.

25. A process for forming an optical element, the process comprising:
providing an optical substrate having a uniform thickness;
providing an optical bulk material having non-uniform thickness;
etching an optical profile into a surface of said optical substrate; and
chemically bonding said planar optical substrate to said optical bulk material.

26. The process of claim 25 wherein the step of providing an optical substrate having uniform thickness comprises providing a fused silica optical substrate having uniform thickness.

27. The process of claim 25 wherein the step of providing an optical bulk material having non-uniform thickness comprises providing a fused silica optical bulk material having non-uniform thickness.

28. The process of claim 25 wherein the step of etching a pattern into a surface of said optical substrate comprises reactive ion etching.

29. The process of claim 25 wherein the step of chemically bonding said planar optical substrate to said optical bulk material comprises contacting surfaces to be bonded with a high pH substance, then bringing said surfaces into contact.

30. A product formed by the process of claim 25.

31. A grism formed by the process of claim 25.

32. A grating-bearing lens formed by the process of claim 25.

33. A process for forming an optical element, the process comprising:
providing an optical substrate having a uniform thickness;
providing an optical bulk material having non-uniform thickness;
etching multiple copies of a desired an optical profile into a surface of said optical substrate;
testing each of the multiple copies of said profile for desired performance and separating acceptable copies from unacceptable copies of said profile by dicing said substrate; and
direct bonding one of said acceptable copies of said profile to said optical bulk material.

34. The process of claim 33 wherein said optical bulk material is a prism, said profile is a grating structure, and said direct bonding comprises chemical bonding.

35. A process for forming a prism element incorporating a grating, the process comprising:
providing an optical bulk material in the form of a prism;
etching a desired grating structure directly into a surface of said prism.
